(19) United States
(12) Patent Application Publication
(10) Pub. No.: US 2024/0262629 A1
(43) Pub. Date: Aug. 8, 2024

(54) APPARATUS AND METHOD FOR AUTOMATICALLY INTRODUCING OBJECTS INTO BOXES

(71) Applicant: I.M.A. INDUSTRIA MACCHINE AUTOMATICHE S.P.A., OZZANO DELL'EMILIA (IT)

(72) Inventors: Dario REA, OZZANO DELL'EMILIA (IT); Fiorenzo DRAGHETTI, OZZANO DELL'EMILIA (IT); Alessandro CARAPIA, OZZANO DELL'EMILIA (IT); Filippo ROSA, OZZANO DELL'EMILIA (IT); Giacomo COLLEPALUMBO, OZZANO DELL'EMILIA (IT)

(21) Appl. No.: 18/567,591

(22) PCT Filed: Jun. 7, 2022
(86) PCT No.: PCT/IT2022/050159

§ 371 Date: Dec. 6, 2023

(30) Foreign Application Priority Data
Jun. 8, 2021 (IT) IT102021000014870

(51) Int. Cl. B65G 11/12; B65B 35/58; B65G 11/14; B65G 65/23

(52) U.S. Cl. CPC B65G 11/123; B65B 35/58; B65G 11/143; B65G 65/23

(57) ABSTRACT

Apparatus (10) for automatically introducing one or more objects (O) into a box (S), disposed in an introduction zone (Z), wherein the objects (O) are fed on a level (L2) disposed above the introduction zone (Z), wherein the apparatus (10) comprises transfer means (22, 25) for transferring by gravity the one or more objects (O) from the level (L2) to the introduction zone (Z).

### FIELD OF THE INVENTION

The present invention concerns an apparatus for automatically introducing objects of various kinds and sizes into boxes, which can be applied, for example but not restrictively, in plants for packaging and sorting objects purchased by mail, also in electronic form.

### BACKGROUND OF THE INVENTION

In the context of plants for shipping objects, deriving, for example, from purchase orders made online, the need is known to fill each of a plurality of empty boxes with the objects associated with a specific purchase order made by a customer, to then proceed with the shipment of the package to the address indicated by the customer.

Normally, since each order can concern different objects having the most different shapes, weights and sizes, the corresponding box must also be chosen appropriately, so that it is as small as possible, but in any case able to contain all the objects associated with a specific order.

For this reason, a plurality of types of boxes of standardized sizes are usually provided, on the basis of their sizes and therefore their capacity.

Generally, a boxing station of the plant is fed both with empty boxes of different types, and also with different batches of objects of different kinds and sizes, each to be introduced into an appropriate box, in which each batch groups together a single object or a plurality of objects belonging to the same purchase order.

Nowadays, especially large e-commerce companies find that they need to manage and process several thousand purchase orders per day, and therefore each filling station must have a high productivity while maintaining an optimization of the volume occupied by the objects inside the box, both to reduce the consumption of packaging material and also to make transport more efficient. In some solutions known in the state of the art, the most appropriate box format is chosen by the operator or suggested to the operator by a visual system, for example through video instructions.

Normally, after a suitably trained operator has picked up a folded box of the appropriate size, in a flattened condition, the operator forms an open box, closes the bottom, manually fills it with the object or objects of each purchase order, and finally provides to close it.

One disadvantage of this manual filling is that it is slow and expensive.

Another disadvantage of this known solution is that, having to carry out the above operations in a short time, the operator easily risks disposing the object/objects of the same purchase order in a non-optimal way inside the box, with a consequent increase of unused volume in the box.

Another known solution, described for example by U.S. Pat. No. 10,301,121, provides that the objects of each batch are disposed in a container having an openable bottom. Each container is taken above a box of appropriate size, after which the bottom of the container is opened and the objects of the batch are dropped into the box.

One disadvantage of this other solution is that the unloading of the objects from the containers causes a random scattering of the objects into the box below, often making it difficult to close it. In fact, to remedy this disadvantage it is necessary to provide the presence of an operator, which contributes to slowing down the filling operation and increases costs.

Other solutions of the known type, known in the sector by the term “wrap-around”, provide to make the box directly around the objects to be boxed, starting from a single sheet of cardboard in an extended condition. Although appreciated because they allow to minimize the volume of the package to be shipped, these solutions are only suitable for packaging stackable products. Furthermore, these latter known solutions necessarily require complicated, bulky and expensive equipment, and the presence of a specialized operator to carry out the correct disposition of the stackable objects entering the machine. Another disadvantage of these known solutions is that the speed with which the objects are wrapped must be rather reduced in order to prevent them from being positioned incorrectly, falling from the pile in which they are disposed.

In another technical field, different from that of the shipment of objects deriving, for example, from purchase orders made online, packaging machines are known which provide to transport the objects on one or more transfer devices, in which the objects can descend by falling between these devices.

Examples of such machines are described in U.S. Pat. No. 6,884,016, relating to an apparatus and a method for grouping articles together, and in U.S. Pat. No. 10,850,875, relating to an apparatus for handling food snacks, for example chips, having a curved three-dimensional shape.

One disadvantage of these solutions is that they are not suitable for transferring objects of different kinds and sizes into boxes.

In fact, in this specific technical field some technical problems arise, such as optimizing the space inside the boxes, or ensuring that the open upper flaps of the box remain open in the intended position, without disturbing the filling operation.

The solution described by U.S. Pat. No. 6,884,016 is optimized for a single type of article and, therefore, is not able to manage objects of various kinds and sizes. Furthermore, the conformation of the chute which makes the articles descend is such that it is not suitable for automatically filling boxes.

The solution described by U.S. Pat. No. 10,850,875 is also optimized for a single type of article, which is however of a very complex shape. These are fragile items that can break easily and therefore this solution cannot provide steps of free falling due to gravity into a box. Therefore, this solution is also not suitable for automatically filling boxes with objects of various types and sizes.

There is therefore a need to perfect an apparatus for automatically introducing objects of different kinds and sizes into boxes that can overcome at least one of the disadvantages of the state of the art.

Therefore, one purpose of the present invention is to provide an apparatus and to perfect a method for automatically introducing objects into boxes which are simple and which allow to speed up the operations of packaging the boxes and therefore to obtain high productivity.

Another purpose of the present invention is to provide an apparatus and to perfect a method for automatically introducing objects into boxes that can be easily implemented in already existing packaging plants, in particular in the electronic commerce (e-commerce) sector.

Another purpose of the present invention is to provide an apparatus and to perfect a method for automatically introducing objects into boxes that also allow to obtain an optimal disposition of the objects inside the corresponding box.

Another purpose of the present invention is to provide an apparatus and to perfect a method for automatically introducing objects into boxes without needing the assistance of an operator, who can therefore be used for checking and supervision purposes, significantly reducing the operator's manual operations.

Another purpose of the present invention is to provide an apparatus for automatically introducing objects into boxes in which possible maintenance, inspection and checking operations, both planned in time and also extraordinary, can be easily carried out.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, an apparatus for automatically introducing one or more objects into a box, disposed in an introduction zone, wherein the objects are fed in correspondence with a level disposed above, that is, higher than, the introduction zone, which overcomes the limits of the state of the art and eliminates the defects present therein, comprises transfer means for transferring the one or more objects from said level to the underlying introduction zone.

In accordance with one aspect of the present invention, the transfer means comprise a first transfer device and a second transfer device. The first transfer device is configured to temporarily hold and then transfer by gravity the one or more objects from said level to the second transfer device, which is disposed between the first transfer device and the introduction zone, so as to transfer the one or more objects coming from the first transfer device into the box.

In accordance with another aspect of the present invention, the second transfer device comprises at least a first body configured to be selectively disposed in an inclined position with respect to said level in order to transfer the one or more objects coming from the first transfer device directly into the box.

In accordance with another aspect of the present invention, the first transfer device comprises at least one mobile structure configured to accommodate a container in which the one or more objects are disposed. The first transfer device is mobile about an axis of rotation between a loading position, in which the mobile structure receives the container that houses the one or more objects from transport means, and an unloading position, in which the mobile structure, after having rotated about the axis of rotation for a predefined segment, flips the container in order to transfer the one or more objects from the container to the second transfer device. When the mobile structure is in the unloading position, it is also configured to hold the container.

In accordance with another aspect of the present invention, the mobile structure comprises a support plane which is substantially aligned with said level in order to receive the container thereon, wherein the support plane is rotatable about the axis of rotation.

In accordance with another aspect of the present invention, the mobile structure also comprises retention members configured to hold the container when the mobile structure is in the unloading position.

In accordance with another aspect of the present invention, the mobile structure comprises a fixed structure within which the mobile structure is disposed in a rotary manner; the fixed structure has at least one closed lateral wall and a lower aperture through which the one or more objects pass in order to reach the underlying second transfer device when the mobile structure is in the unloading position.

In accordance with another aspect of the present invention, the second transfer device is mobile between a receiving operating condition, in which the first body receives the one or more objects from the first transfer device, and an unloading operating configuration, in which the first body is disposed in the inclined position in order to transfer the one or more objects directly into the box. In one embodiment, in the receiving operating condition the first body is disposed in a horizontal plane, parallel to said level, but below the latter.

In accordance with another aspect of the present invention, the second transfer device also comprises a second body. The first body is disposed above the second body and mounted rotatable about a horizontal axis. The axis of rotation of the first body is perpendicular to the axis of rotation of the first transfer device.

In accordance with another aspect of the present invention, the first body has a substantially V-shaped transverse shape.

In accordance with another aspect of the present invention, the first body and the second body have a reciprocally mating transverse shape, substantially V-shaped, wherein the second body is configured to at least partly contain the first body.

In accordance with another aspect of the present invention, the second body is mounted slidingly on a support between a retracted position, in which the second body is disposed completely under the first body, and an advanced position, in which the second body is disposed only partly under the first body, in such a way as to receive the one or more objects from the first body and then let them fall directly into the box.

In accordance with another aspect of the present invention, at least one of either the first body or the second body comprises two motorized belts inclined laterally, in such a way that each of them forms a respective side of the V.

In accordance with another aspect of the present invention, the support is fixed and disposed inclined with respect to said level.

In accordance with another aspect of the present invention, the support is mobile so as to be able to vary the inclination of the second body with respect to said level.

In accordance with another aspect of the present invention, the level lies on a substantially horizontal plane.

In accordance with another aspect of the present invention, it also comprises first transport means configured to transport at least one empty box toward the introduction zone, wherein the sizes of the empty box are selected as a function of the overall volumes of the one or more objects to be introduced inside it.

In accordance with another aspect of the present invention, a method for automatically introducing objects into boxes comprises:
a step of feeding an empty box into an introduction zone, the box having a closed bottom and an opposite upper aperture;
a step of supplying to a first transfer device at least one or more objects to be introduced into the box, at a level disposed above the introduction zone;
a first step of transferring the one or more objects, by gravity, from the first transfer device to a second transfer device, disposed between said level and the introduction zone;
a second step of transferring the one or more objects, by gravity, from the second transfer device directly to the box, wherein the second transfer step provides to rotate about an axis of rotation a first body of the second transfer device so that the first body is disposed inclined by a determinate angle of inclination with respect to a horizontal plane, in order to facilitate the descent of the one or more objects directly toward the box.

In accordance with another aspect of the present invention, the second transfer step provides to dispose the second transfer device in proximity to the box, in contact with the flaps of the box that delimit its upper aperture.

In accordance with another aspect of the present invention, the method also provides, before the step of supplying the one or more objects to the first transfer device, a step of removing the empty box from a magazine that has a plurality of boxes of different sizes. The choice of the size of the box to be subsequently disposed in the introduction zone is made as a function of the size of the one or more objects that will be inserted, so as to minimize the empty space, that is, the space not occupied by the one or more objects after they have been introduced into the box.

In accordance with another aspect of the present invention, the method also provides a step of forming the empty box starting from a pre-glued box disposed in a flattened configuration, which is then folded in order to create the closed bottom and the opposite upper aperture thereof. The forming step begins before the step of supplying the one or more objects to the first transfer device, moreover, the size of the box is chosen as a function of the size of the one or more objects, so as to minimize the empty space in the box, which is not occupied by the one or more objects after these have been introduced into the box.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic lateral view of an apparatus according to a first embodiment of the present invention, in which the apparatus is shown in a first operating step;

FIG. 2 is a section lateral view of the apparatus of FIG. 1, in which the apparatus is shown in another operating step;

FIGS. 3, 4 and 5 are front views of the apparatus of FIG. 1, in which some components have been removed for reasons of clarity, showing an operating sequence of operation;

FIGS. 6, 7, 8 and 9 are schematic lateral views that show a sequence of four different operating steps of an apparatus in accordance with a second embodiment of the present invention;

FIGS. 10 to 12 are lateral views from the left, on an enlarged scale, of a detail of the apparatus of FIG. 6, shown in different operating conditions;

FIG. 13 is a section view, on an enlarged scale, taken along the line XIII-XIII of FIG. 9, of a portion of the apparatus of FIG. 6;

FIG. 14 is an electrical block diagram of the apparatus of FIG. 1;

FIG. 15 is an electrical block diagram of the apparatus of FIG. 6;

FIG. 16 is a block diagram of a plant for packaging and sorting items purchased by mail in which an apparatus in accordance with the embodiments of the present invention is comprised.

We must clarify that in the present description the phraseology and terminology used, such as for example the terms horizontal, vertical, front, rear, high, low and internal, with their declinations, have the sole function of better illustrating the present invention with reference to the attached drawings and must not be in any way used to limit the scope of the invention itself, or the field of protection defined by the attached claims.

Furthermore, the people of skill in the art will recognize that certain sizes or characteristics in the drawings may have been enlarged, deformed, or shown in an unconventional or non-proportional way in order to provide a version of the present invention that is easier to understand. When sizes and/or values are specified in the following description, the sizes and/or values are provided for illustrative purposes only and must not be construed as limiting the scope of protection of the present invention, unless such sizes and/or values are present in the attached claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

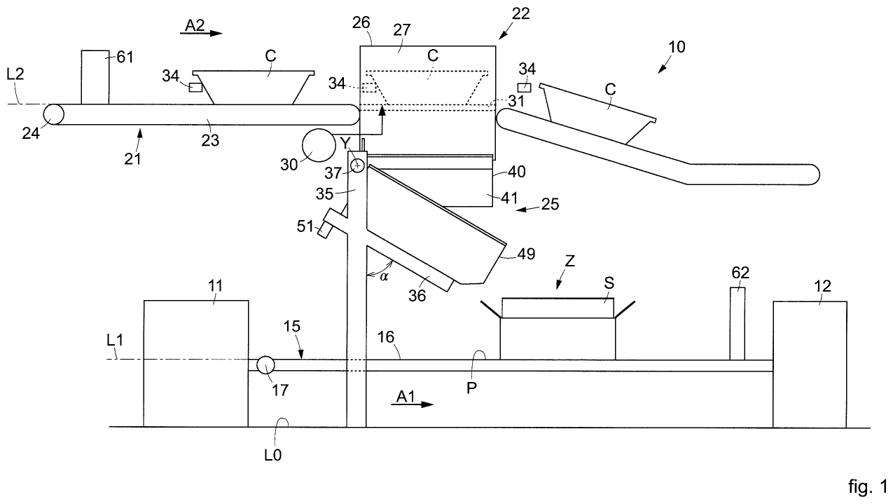

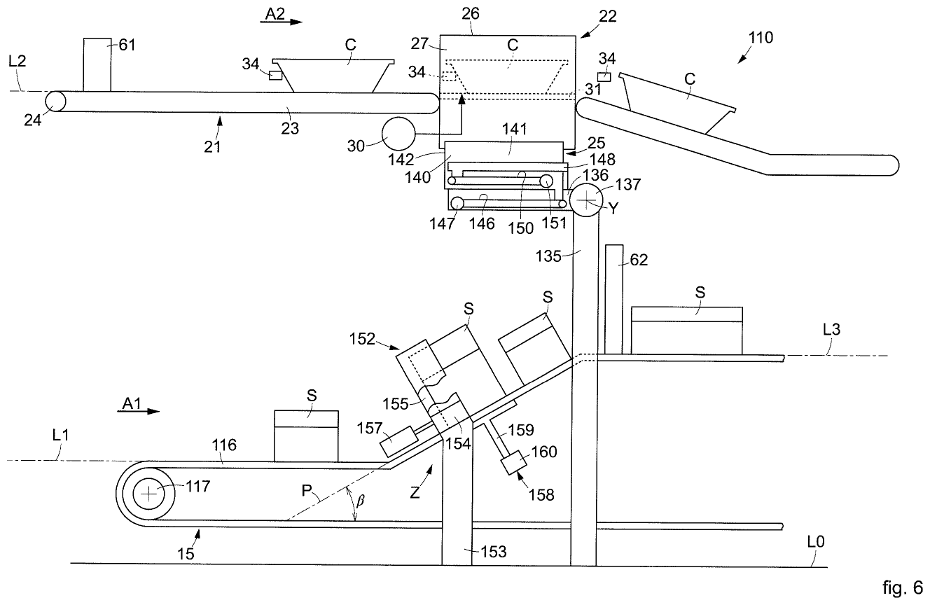

With reference to FIGS. 1 and 6, an apparatus 10, 110 according to the present invention is configured to automatically introduce one or more objects O of various nature and sizes, for example deriving from a purchase order made by a user, inside boxes S. Each box S can have different sizes, according to the volume of the objects O that define its contents.

For example, the apparatus 10, 110 can be part of a more complex plant 100, schematized in FIG. 16, for the automatic management of purchase orders and the corresponding packaging of the objects O, sorted and inserted in special boxes S, which comprises at least one forming station 11, disposed upstream of the apparatus 10, in which the empty boxes S are formed, either manually or automatically, and a closing station 12, disposed downstream of the apparatus 10 and in which the boxes S are closed, either manually or automatically, after the objects O have been introduced therein.

Moreover, the plant 100 can also comprise an aggregation station 13, of a known type, in which the different objects O intended for a same user and/or belonging to the same purchase order are disposed in a container C, for example in the shape of a tray, box, or small tub. Optionally, the plant 100 can also comprise other processing stations, such as for example a final labeling and weighing station, disposed downstream of the closing station 12 and not shown in the drawings, to prepare the delivery to the user, for example home delivery, of each box S including the objects O. In addition, the plant 100 can comprise a station for applying a package tag, such station can be disposed either upstream or downstream of the closing station 12.

The operation of the plant 100 is controlled by a central control unit 101 of the plant which appropriately commands the operation of the forming station 11, closing station 12, aggregation station 13 and labeling and shipping station.

The apparatus 10, 110 comprises first transport means 15 interposed between the forming station 11 and the closing station 12 for selectively transporting the empty boxes S between the stations, passing through a zone Z for introducing the objects O. The first transport means 15 define a rest plane P for the boxes S, on which the boxes S advance in a first direction of advance A1.

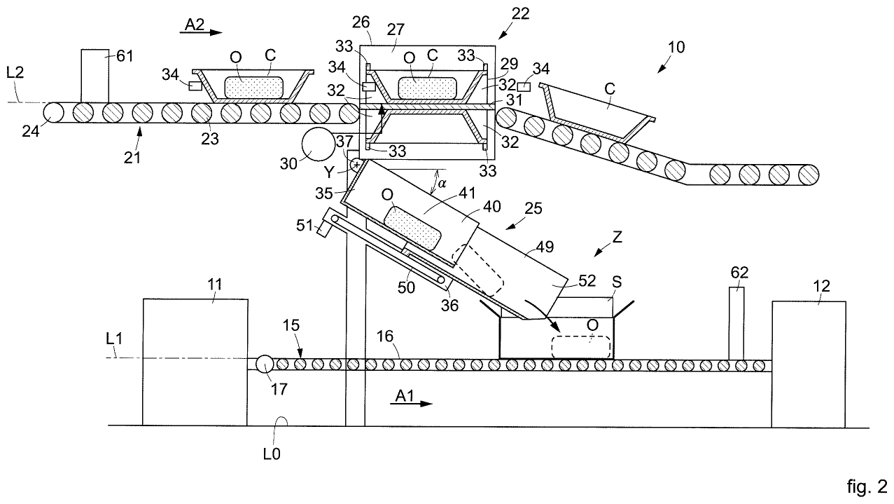

In a first embodiment of the apparatus 10, with reference to FIGS. 1 and 2, the first transport means 15 comprise a first roller conveyor 16, suitable to support the formed boxes S to be transported first empty toward the introduction zone Z and subsequently, after the objects O have been introduced into the boxes S, the boxes S toward the closing station 12.

The roller conveyor is commanded by a first electric motor 17 capable of determining the transport of the boxes S, which are suitably distanced from each other, in a stepwise manner, that is, with incremental advances, in the first direction of advance AL.

The introduction zone Z is disposed in a portion of the roller conveyor 16 interposed between the stations 11, 12, in correspondence with which it is provided that the box S, into which the objects O are to be introduced, stops for a programmed stop, as will be explained in more detail below.

The first transport means 15 are disposed at a first vertical level or height L1, higher than a base L0 which consists, for example, of a floor. In this first embodiment, the rest plane P is substantially horizontal and disposed at the first level L.

The apparatus 10 also comprises second transport means 21 configured to transport the containers C prepared in the aggregation station 13 toward a first transfer device 22, which will be described in detail below.

The second transport means 21 comprise, for example, a second roller conveyor 23, of a type known per se, comprising a first horizontal segment disposed upstream of the first transfer device 22 and positioned at a second level L2, which is higher than the first level L1 and the base level L0, and also a second segment disposed downstream of the first transfer device 22 and inclined downward, in order to facilitate the unloading of the containers C, without objects O, toward a collection station of the plant 100, not shown in the drawings.

The second transport means 21 are capable of transporting the containers C, suitably distanced from each other, in a stepwise manner, that is, with incremental advances, in a second direction of advance A2, first toward the first transfer device 22 and then, after a programmed stop in the latter, toward the collection station. Alternatively, the containers C advance in a continuous manner in the second direction of advance A2 to accumulate in front of the first transfer device 22.

According to one aspect of the present invention, the first transfer device 22 is positioned substantially above the introduction zone Z and it is configured to transfer the objects O present in a container C to an underlying second transfer device 25 disposed at an intermediate level between the introduction zone Z and the second level L2.

In particular, the first transfer device 22 is configured to overturn, one at a time, each container C transported by the second transport means 21 so as to make its content, that is, all the objects O contained therein, fall into the underlying second transfer device 25.

In the example provided here, the first transfer device 22 comprises a fixed structure 26 having a lower aperture 28 and two fixed lateral walls 27, one front and one rear, which laterally delimit the lower aperture 28 on opposite sides. Inside the fixed structure 26 there is rotatably mounted, about a substantially horizontal axis of rotation X, a mobile structure 29 (FIGS. from 3 to 5 and from 10 to 12) suitable to accommodate a container C and configured to rotate in order to flip the container C. The mobile structure 29 is rotated by a third electric motor 30.

The axis of rotation X can be substantially parallel to the second direction of advance A2 of the containers C. Alternatively, the axis of rotation X can be skewed with respect to the second direction of advance A2, so as to facilitate the fall of the objects O from an edge of the container C. This can be especially advantageous if the objects O are small in size.

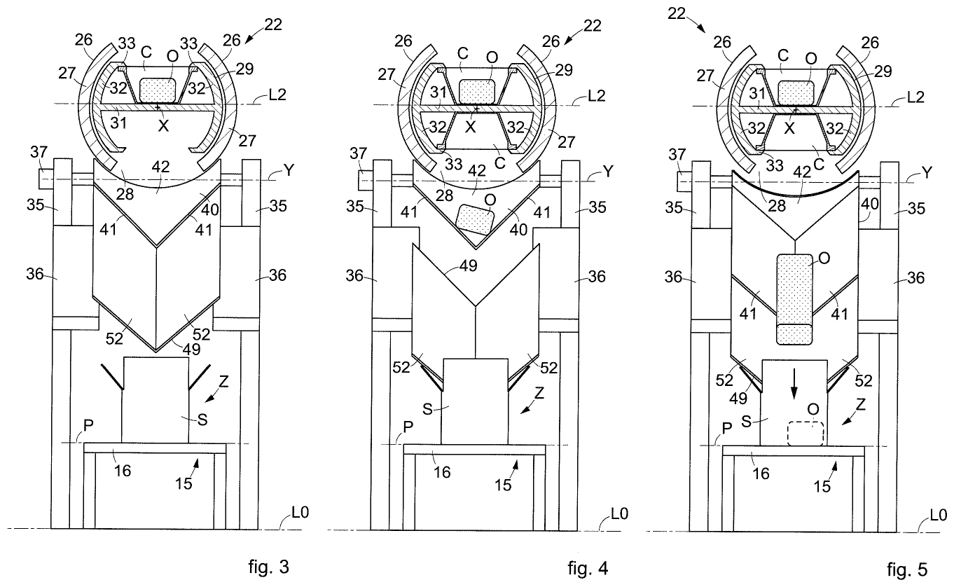

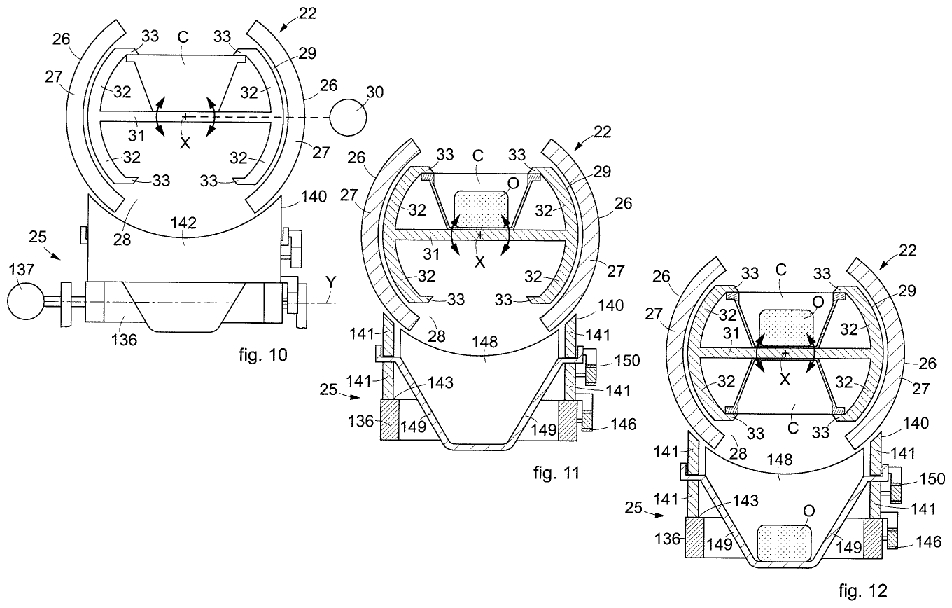

The mobile structure 29 has a substantially H-shaped cross section, symmetrical with respect to a central support plane 31, which in the rest position (FIGS. 3 and 10) is substantially aligned with the second level L2 in order to receive a container C thereon. The mobile structure 29 also comprises two arcuate walls 32 provided with shoulders 33, which are configured as retention members suitable to hold at least one container C, when the latter is flipped.

In one possible embodiment, the support plane 31 can be mobile in a direction perpendicular to the plane on which it lies, so as to lift the container C disposed thereon until the latter abuts against the shoulders 33. In this embodiment, the apparatus 10, 110 can comprise suitable lifting means, of a type known per se and not shown, for example of a mechanical or pneumatic type.

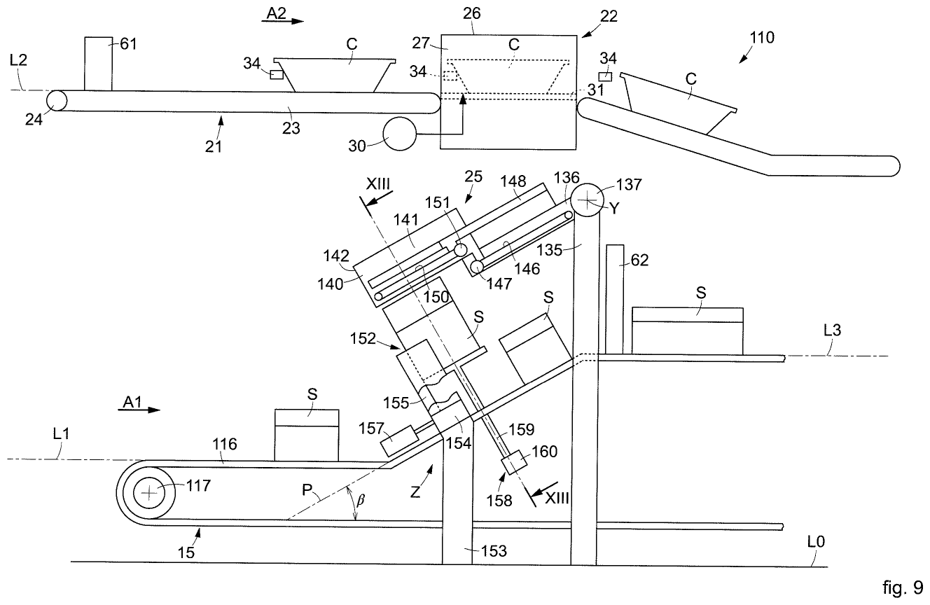

A pusher mechanism 34 (schematically shown in FIGS. 1, 2 and 6-9), of a type known per se and not described in detail, cooperates with each container C carrying the objects O, in order to first push it along a portion of the first segment of the second roller conveyor 23, then on the support plane 31 which is aligned with the second level L2, and finally along the second segment of the roller conveyor 23.

In an operating position, shown in FIGS. 4, 5 and 12, the mobile support structure 29 is rotated by 180° with respect to its rest position. Please note that the symmetrical H-shaped conformation of the mobile structure 29 allows to position a new container C on one side of the support plane 31 when another container C, on the other side of the support plane 31, is flipped, and so on (FIGS. from 3 to 5 and from 10 to 12).

Please also note that the objects O gradually begin to fall from the container C when the latter has been rotated even by only about 100°, this facilitates a gradual fall of the objects O into the second transfer device 25 so as to obtain a more organized disposition of the objects themselves.

Alternatively, the mobile structure 29 can comprise a mobile rolling gate (not shown) disposed to selectively close the lower aperture 28, substantially parallel to the support plane 31 and configured to open only when the mobile structure 29 has made a full rotation of 180°.

The second transfer device 25 is configured to alternatively assume a receiving operating configuration, in which it receives the objects O falling from the first transfer device 22, and an unloading operating configuration, in which it transfers the objects O received into an underlying box S, which is temporarily positioned in the introduction zone Z. In particular, the second transfer device 25 is configured to be disposed in an inclined position with respect to the second level L2, in order to transfer the one or more objects O coming from the first transfer device 22 toward the box S.

In the first embodiment of the apparatus 10, the second transfer device 25 comprises two fixed uprights 35 on which there is pivoted a first body 40 of the second transfer device 25, oscillating with respect to a horizontal axis Y, which is orthogonal to the axis of rotation X, as can be seen in FIGS. 3-5, alternatively between a horizontal rest position (FIG. 1), and an inclined operating position (FIG. 2), in which it is inclined downward by a first angle of inclination a. In particular, the first body 40 is in the horizontal rest position when the second transfer device 25 is disposed in the receiving operating configuration, while it assumes the inclined operating position when the second transfer device 25 is in the unloading operating configuration.

The first angle of inclination α is comprised between about 0° and about 90°, preferably between about 100 and about 45°.

In this first embodiment, the first body 40 has a substantially V-shaped cross section and it is essentially defined by two inclined walls 41 converging downward and joined together. The first body 40 also comprises a terminal wall 42, orthogonal to the inclined walls 41 and disposed in proximity to the part of the first segment of the second roller conveyor 23.

The selective oscillation of the first body 40 is commanded by a fourth electric motor 37.

The second transfer device 25 also comprises a fixed support 36, underlying the first body 40 and disposed in a position inclined downward by the first angle of inclination α.

A second body 49 of the second transfer device 25 is mounted slidingly on the fixed support 36 along a longitudinal axis thereof between a retracted position (FIGS. 1, 3, 6 and 7), in which the second body 49 is disposed completely below the first body 40, and an advanced position (FIGS. 2, 4, 5, 8 and 9), in which the second body 49 is disposed only partly below the first body 40, so as to receive the objects O from the first body 40 and then let them fall directly into the box S. In particular, the sliding of the second body 49 is commanded by a transmission belt 50 attached thereto and made to selectively rotate, in both directions, by a fifth electric motor 51 mounted on the fixed support 36 (FIG. 2).

The second body 49 has a transverse shape mating with that of the first body 40, that is, substantially V-shaped, and it is disposed in such a way as to contain externally at least a part of the first body 40 when the latter is in the inclined operating position.

In particular, the second body 49 can essentially consist of two inclined walls 52 converging downward and joined together.

Alternatively, in variants not shown, at least one of either the first body 40 or the second body 49 can essentially consist of two motorized belts directed along the axis of sliding thereof and inclined laterally, each of them forming one side of 1o the V.

In another possible variant, the second body 49 can essentially consist of a vibrating carpet, the vibration of which is suitable, during use, to cause the one or more objects O received from the first body 40 to fall toward the box S.

Optionally, the apparatus 10, 110 also comprises first detection means 61 (FIGS. 1, 2 and from 6 to 9), disposed upstream of the first transfer device 22 and associated with the second transport means 21 to recognize the objects O contained in each of the containers C transported by the second transport means 21.

Some embodiments of the present invention provide that the first detection means 61 can recognize the objects O by reading an identification code, for example a bar code, disposed on the corresponding container C. Alternatively, or in addition, the first detection means 61 can recognize the objects O, or detect their overall volume, through direct recognition by means of a video camera or other suitable means. Please note that, in some embodiments, optical vision systems, such as the video camera as above, can be configured only to detect the overall volume of the objects O, without performing an individual recognition of the single objects.

The first detection means 61 are disposed in the first segment of the second roller conveyor 23, upstream of the first transfer device 22, at a distance from the latter such as to guarantee the correct synchronization, in the introduction zone Z, between the box S and the objects O to be introduced therein.

The apparatus 10 also comprises second detection means 62, disposed downstream of the introduction zone Z to detect the disposition of the objects O in the boxes S after the introduction of the objects O.

Some embodiments of the present invention provide that the second detection means 62 can recognize whether the objects O are correctly disposed inside the box S, according to a programmed pattern, or if a rearrangement is necessary before entering the closing station 12.

If the objects O are correctly disposed inside the box S, the latter can go directly to the closing station 12, please see the bottom arrow that connects block 10 with block 12 in FIG. 16.

If the objects O protrude from a box S′ or they are not correctly disposed in it, then the intervention of the operator or a robotic arm is required to dispose them correctly. In this case, the box S′ transits in a sorting station 14 in which the objects O are rearranged inside the box S′, either manually by the operator or automatically by means of automated members, from this sorting station 14 the box S′ can then be transported toward the closing station 12. This option is schematized in FIG. 16 by the top arrow that connects block 10 with block 12, passing through station 14.

Optionally, the apparatus 10, 110 can comprise a filler device (not shown) interposed between the second detection means 62 and the closing station 12. The filler device is configured to insert a filling element into the box S, suitable to fill any empty spaces of the box in order to stabilize the disposition of the objects O therein.

The apparatus 10 comprises a programmable control unit 20, which communicates with the electric motors 17, 24, 30, 37 and 51 in order to command the operation of the first and second transport means 15, 21 and of the first and second transport devices 22, 25.

Furthermore, the programmable control unit 20 communicates with the first and second detection means 61, 62 to receive the detected information from them and consequently command the operation of the apparatus 10 according to whether or not the information detected corresponds to the information expected.

In a second embodiment, with reference to FIGS. from 6 to 12, the apparatus 110 essentially comprises all the parts described heretofore, with some structural differences of the first transport means 15 and of the second transfer device 25.

Consequently, all parts of the second embodiment which are common to the first embodiment described above are named in the same way and indicated by the same reference numbers, and their detailed description will not be repeated hereafter for reasons of brevity.

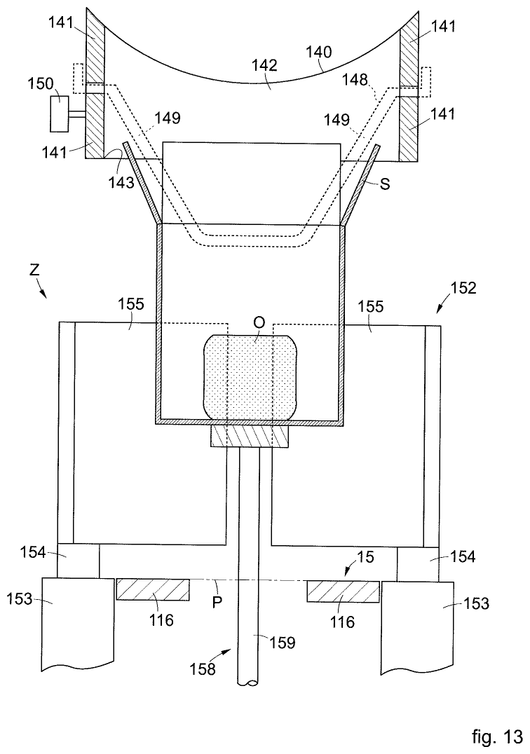

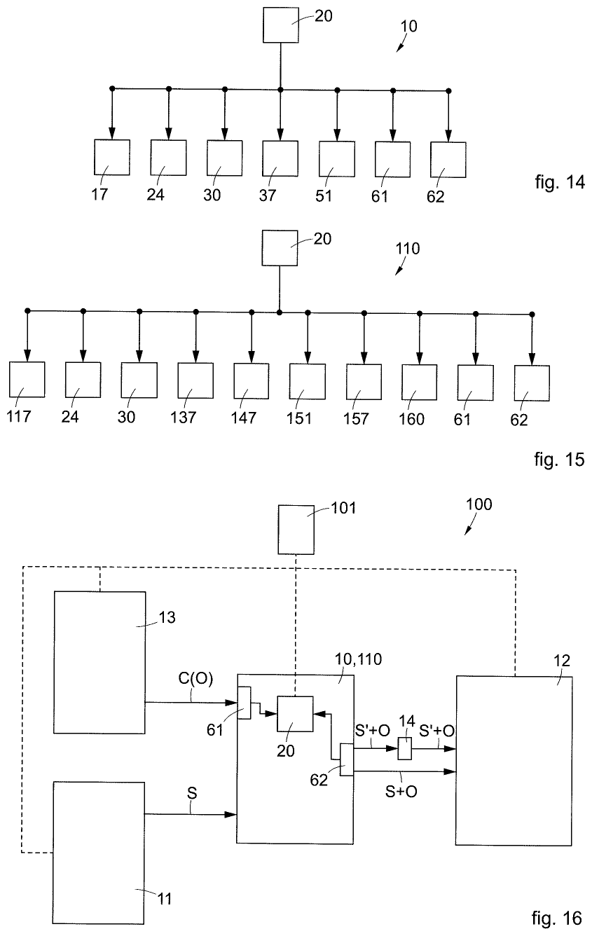

In the second embodiment, the first transport means 15 comprise a pair of transporter belts 116 (FIG. 13) which are horizontal, parallel and coplanar to each other so as to allow the boxes to rest directly on them. Furthermore, the transporter belts 116 are distanced from each other to define an empty intermediate zone. The two transporter belts 116 are suitably guided by guide means of a known type and not shown in the drawings, so as to have a first horizontal segment, upstream of the introduction zone Z, and a second segment, inclined upward by a second angle of inclination β in correspondence with which the introduction zone Z is disposed, and a third horizontal segment, downstream of the introduction zone Z.

The first segment develops in a horizontal plane, coplanar with the rest plane P and disposed at the first vertical level or height L1. The second segment is disposed at a third level L3, higher up, that is, at a higher vertical height, compared to the first level L1. The third level L3 is intermediate between the first and second levels L1, L2. Indicatively, the first level L1 is disposed at about 300 mm from the base L0 and the third level L2 is disposed at about 800 mm from the base L0.

The second angle of inclination β is comprised between about 0° and about 90°, preferably between about 100 and about 45°.

The two transporter belts 116 are commanded by a sixth electric motor 117 capable of determining the advance of the boxes S, which are suitably distanced from each other, in a stepwise manner, that is, with incremental advances, in the first direction of advance A1, first toward the introduction zone Z and then, after a programmed stop in the latter, toward the closing station 12.

Furthermore, in the second embodiment, the second transfer device 25 comprises a mobile support 136, which substantially has a U-shaped cross section.

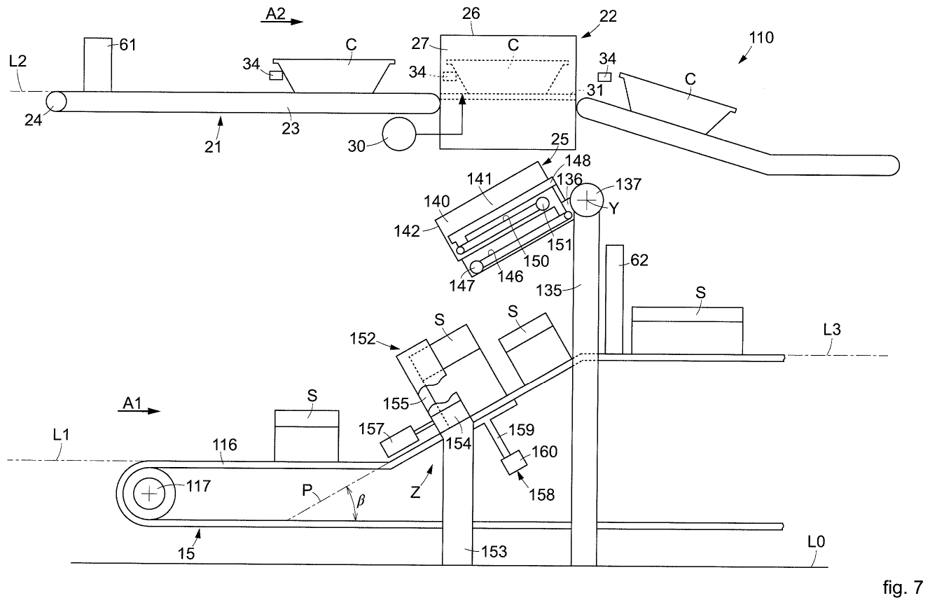

In particular, the mobile support 136 is pivoted with one of its ends, which forms the base of the U, on two fixed uprights 135 in order to be able to oscillate with respect to a horizontal axis Y, which is orthogonal to the axis of rotation X, between a rest position (FIG. 6), in which it is substantially horizontal, and an operating position (FIGS. 7, 8 and 9), in which it is inclined downward by a third angle of inclination γ.

The third angle of inclination γ is comprised between about 100 and about 45°, and can advantageously be the same as the second angle β.

The selective oscillation of the mobile support 136 is commanded by a seventh electric motor 137.

In this second embodiment, a hopper 140 is mounted on the mobile support 136 in an axially sliding manner with respect to it, in a direction perpendicular to the horizontal axis Y.

The hopper 140 (FIG. 13) is defined by two flanks 141 parallel to each other and disposed on opposite sides and equidistant with respect to a vertical plane passing through the axis of rotation X, and by a terminal wall 142 which is perpendicular to the flanks 141 and extends so as to join them. In addition, the hopper 140 has an aperture 143 at the bottom, through which the one or more objects O pass.

In particular, the hopper 140 is commanded by a first transmission belt 146 attached to it and made to selectively rotate, in both directions, by an eighth electric motor 147 mounted on the mobile support 136.

Furthermore, the second transfer device 25 comprises a closing member 148, disposed inside the hopper 140 and mounted slidingly with respect thereto, to selectively open or close the aperture 143 of the latter, as will be described in detail below.

The closing member 148 has a V-shaped cross section and has at least two inclined walls 149 converging downward.

The hopper 140 and the closing member 148 respectively define a first and a second body of the second transfer device 25, which are reciprocally cooperating in order to define a temporary seating for receiving the objects O falling from the first transfer device 22 (FIG. 12).

In particular, the closing member 148 is commanded by a second transmission belt 150 attached thereto and made to selectively rotate, in both directions, by a ninth electric motor 151, mounted on one of the flanks 141 (on the left in FIG. 13) of the hopper 140.

In the second embodiment, the apparatus 110 also comprises a positioning device 152 (FIGS. from 6 to 9) disposed in correspondence with the introduction zone Z and configured to selectively couple with an external part of the box S, during the operation of inserting the objects, so that the box S remains inclined and stationary in a determinate position, in order to facilitate the disposition of the objects O introduced therein according to the correct orientation.

The positioning device 152 comprises two fixed uprights 153, on which two sliding guides 154 are attached, which in turn support two panels 155 (FIG. 13) sliding selectively between an open position in which they allow the advance of the boxes S, made to advance by the transporter belts 116, and a closed position, in which they contact an external rear part of the box S when the latter is in the introduction zone Z.

The panels 155 have an L-shaped cross section and their sliding between the open position and the closed position occurs perpendicularly to the direction of advance A1 of the boxes, and it is commanded by an actuator 157.

The apparatus 110 also comprises a lifting device 158 configured to selectively lift the box S which is located in the introduction zone Z in a direction perpendicular to the transporter belts 116, that is, toward the second transfer device 25.

This solution advantageously allows to also bring boxes S of smaller sizes close to the second transfer device 25, which would otherwise be too far away from it. This allows to adjust the distance that the objects O fall from the second transfer device 25 to the box S.

Some embodiments of the present invention provide that the lifting device 158 comprises a pusher element 159 connected to a rod of a linear actuator 160 and configured to selectively contact the bottom of the box S that is disposed in the introduction zone Z. In particular, the pusher element 159 is sized in such a way as to pass between the transporter belts 116 with clearance.

The apparatus 110 comprises a programmable control unit 20, which communicates with the electric motors 24, 30, 117, 137, 147, 151, with the actuators 157 and 160 to command the operation of the first and second transport means 15, 21, of the first and second transfer devices 22, 25, of the positioning device 152 and of the lifting device 158.

Furthermore, also in this embodiment it is provided that the programmable control unit 20 communicates with the first and second detection means 61, 62 to receive the detected information from them and consequently command the operation of the apparatus 10 according to whether or not the information detected corresponds to the information expected.

Below we will describe the operation of an apparatus 10, 110 as described heretofore, which corresponds to a method for automatically introducing objects into boxes according to the present invention.

For example, suppose that the objects O arrive at the apparatus 10 from an aggregation station 13 (FIG. 16), in which each batch of objects O corresponding to a determinate purchase order is contained in one of the containers C, by means of the second transport means 21 (FIGS. 1 and 6).

Optionally, each container C passes in proximity to the first detection means 61 which recognize its contents in order to allow the forming station 11 to link a box S of suitable sizes with the container C. In one embodiment, the recognition of the objects occurs through the reading, by the detection means, of a bar code disposed outside the container C, such code bearing the information relating to the objects contained therein. In particular, each box S is picked up from a magazine having a plurality of boxes of different sizes, and the choice of box is made as a function of the sizes of the objects O of the linked order, so as to minimize the empty space in the box S that is not occupied by the object or objects O.

A determinate empty box S is formed starting from a pre-glued box, in a flattened configuration, which is folded to create its closed bottom and its opposite upper aperture, to be subsequently disposed in the introduction zone Z. This step of forming the box S begins advantageously before the step of supplying the determinate container C containing the objects O to be introduced into that specific box S at the first transfer device 22. Furthermore, the shape of the box S is created as a function of the sizes of the object or objects O contained in the container C, so as to minimize the empty space in the box S.

The different boxes S, already formed and linked to the containers C in a coordinated manner, arrive at the apparatus 10, 110 from the forming station 11 by means of the first transport means 15.

Furthermore, the boxes S are preferably transported on the first transport means 15 with their largest size parallel to the first direction of advance A1, in order to facilitate the introduction of the objects O, as will be seen below.

The first transport means 15 and the pusher mechanism 34, controlled by the control unit 20, take, in a stepwise manner, a certain container C substantially on the support plane 31 and, at the same time, a certain box S, with adequate sizes as a function of the batch contained in the specific container C, in correspondence with the introduction zone Z.

In particular, in the first embodiment of the apparatus 10, the box S advances on the first roller conveyor 16, set in motion by the first electric motor 17 controlled by the control unit 20, until it reaches the introduction zone Z.

Instead, in the second embodiment of the apparatus 110, the box S advances on the transporter belts 116, set in motion by the sixth electric motor 117 controlled by the control unit 20, and the panels 155 of the positioning device 152 are in the open position, thus allowing the box S to enter the introduction zone Z. Therefore, when the box S is completely in the introduction zone Z, the control unit 20 commands the actuator 157 so that the panels 155 are taken, by sliding, into their closed position, so that an external surface of the box S can rest on them, thus defining a precise reference position.

Furthermore, when the box S is transported into the introduction zone Z, the control unit 20 commands the second electric motor 24 so that the mobile structure 29 performs a rotation of 180° in order to flip the container C disposed thereon and transfer the objects O contained therein into the second transfer device 25. The rotation of the mobile structure 29 can also occur before the box S reaches the introduction zone Z, for example while the box S is moving in the first direction of advance A1.

In the first embodiment, at the end of this step the one or more objects O are temporarily inside the first body 40 which is still in its horizontal rest position (FIG. 4). Instead, in the second embodiment, the one or more objects O are inside the hopper 140 resting on the bottom wall of the closing member 148 (FIG. 12) which closes the aperture 143 of the hopper 140.

Optionally, the control unit 20 drives the pusher mechanism 34 again to take another container C on the support plane 31 of the mobile structure 29 of the first transfer device 22 (FIGS. 2, 4, 5 and 12). Please note that, in this case, with every half turn of the mobile structure 29, an empty container C is taken back into alignment with the second level L2, pushed toward the second segment of the roller conveyor 23 and replaced by a new container C.

Subsequently, in the first embodiment, the control unit 20 drives the fourth electric motor 37 to make the second body 49 slide with respect to the support 36 and take it from the retracted position, in which it is disposed below the first body 40, to the advanced position, in which the second body 49 is only partly disposed below the first body 40 so that it extends toward the box S, which is in the introduction zone Z. In this case, the second body 49 contacts and is at least partly inserted inside the box S. Please note that the V-shaped cross section of the second body 49 advantageously keeps the flaps of the box S open during the introduction of the objects O, preventing any closures of the box S.

Then, to complete the operation of introducing the objects O, the control unit 20 drives the fourth electric motor 37 in order to take the first body 40 into the inclined work position, causing the one or more objects O present on the first body 40 to fall. This step causes the objects to be disposed oriented with their largest size along the longitudinal extension of the first body 40. The one or more objects O slide toward the second body 49, the shape of which is suitable to keep them oriented as in the first body 40, that is, in such a way that their largest size is disposed in the direction of the long side of the box S, and finally inside the box S.

Alternatively or in addition, in the event that the second body 49 consists of two motorized belts, the insertion of the objects O will be facilitated by the relative motion of advance between the box S and the motorized belts themselves.

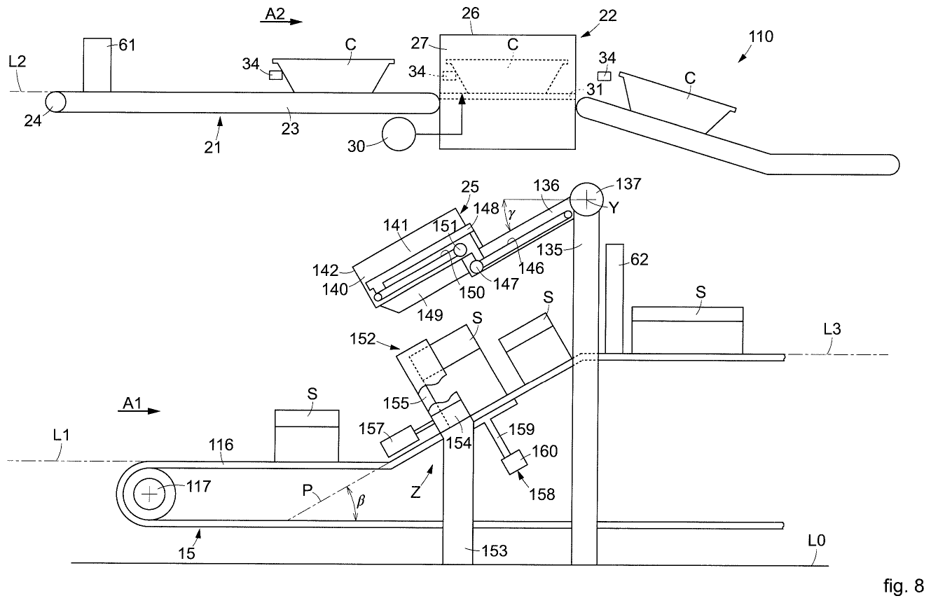

Instead, in the second embodiment, the seventh electric motor 137 takes the mobile support 136 into its operating position (FIG. 8), that is, inclined by the angle β. This inclination positions the one or more objects O contained in the hopper 140 substantially abutting against the terminal wall 142 of the latter.

Then, by means of the eighth electric motor 147, the hopper 140 is made to slide with respect to the mobile support 136, which remains stationary, thus moving it away from the axis of rotation Y and disposing it exactly above the box S, which is disposed in the introduction zone Z (FIG. 8).

Then, the box S, as a function of its sizes, is possibly lifted with respect to the rest plane P and taken close to the second transfer device 25, so that the distance between the bottom of the closing member 148 and the bottom of the box S is as small as possible, compatibly with the sizes and volume of the objects O to be introduced into the latter.

This allows to keep the upper flaps of the box S open, because the inclined walls 149 (dashed line in FIG. 13) of the closing member 148 are inserted, at least partly, inside the box S. Furthermore, this step advantageously contributes to guaranteeing that the objects O actually fall inside the box S, that is, without them falling outside it.

Please note that the box S, during its lifting, remains inclined by the second angle β and is held in position by the panels 155 of the positioning device 152. To complete the operation of introducing the objects O, the control unit 20 then drives the ninth electric motor 151 in order to make the closing member 148 slide toward the horizontal axis Y so that the objects contained in the hopper 140 descend through its aperture 143 into the box S below. The inclined position of the second transfer device 25 facilitates the transfer of the objects O into the box S and allows the same objects O to always be placed correctly inside the latter. In fact, it is known that any object falling into a box tends to occupy the lower corner of the latter. Subsequently, the box S is possibly lowered by the lifting device 159 and returned to the transporter belts 116.

When the box S into which the objects O have been introduced goes beyond the introduction zone Z and returns to a horizontal position, the same objects O settle better and occupy the space inside the box S in an optimal manner.

Possibly, during the step of introducing the objects O, a package tag can be applied to the box S, so that the box S is uniquely associated with the order it contains. The package tag will be read in the next labeling station so that the correct shipping address is applied.

When the operation of introducing the objects O is completed and the second transfer device 25 has been returned to the receiving operating configuration below the first transfer device 22, the control unit 20 drives the third electric motor 30 in order to rotate the mobile structure 29 by 180°, taking the container C that has just been emptied back into alignment with the second transport means 21 and, consequently, flipping the other container C previously positioned on the support plane 31. Then, the control unit 20 also drives the pusher mechanism 34 in order to displace the emptied container C toward the second segment of the second roller conveyor 23 and to simultaneously take another container C onto the support plane 31 of the first transfer device 22.

Subsequently, the operation of introducing the objects O described above is repeated with another container C positioned on the support plane 31 of the first transfer device 22 and a new empty box S disposed in the introduction zone Z.

From what disclosed above it is clear that the entire operation of introducing the objects O is completely automated and occurs in a very short time, of the order of a few seconds, so that a high productivity is achieved.

Moreover, thanks to the fact that the introduction of the objects O into the box S occurs by keeping at least the second transfer device 25 inclined, the objects O will also be oriented and disposed in an optimal manner inside the box S, so that even a subsequent box closing operation can also be done in a fully automated manner.

It is clear that modifications and/or additions of parts or steps may be made to the apparatus 10, 110 and to the corresponding method for automatically introducing objects into boxes as described heretofore, without departing from the field and scope of the present invention as defined by the claims.

In the following claims, the sole purpose of the references in brackets is to facilitate reading and they must not be considered as restrictive factors with regard to the field of protection claimed in the specific claims.

1. Apparatus for automatically introducing one or more objects into a box, disposed in an introduction zone, wherein said one or more objects are fed on a level disposed above said introduction zone, wherein said apparatus comprises transfer means for transferring said one or more objects from said level to said underlying introduction zone, said transfer means comprising a first transfer device and a second transfer device, said first transfer device being configured to temporarily hold and then transfer, by gravity, said one or more objects from said level to said second transfer device, which is disposed between said first transfer device and said introduction zone, so as to transfer said one or more objects coming from said first transfer device into said box and wherein said second transfer device comprises a first body configured to be selectively disposed in an inclined position with respect to said level in order to transfer said one or more objects coming from said first transfer device directly into said box.

2. Apparatus as in claim 1, wherein said first transfer device comprises at least one mobile structure configured to accommodate a container which houses said one or more objects, said first transfer device being mobile about an axis of rotation between a loading position, in which said mobile structure receives said container housing said one or more objects from transport means, and an unloading position in which said mobile structure, after having rotated by a predefined angle about said axis of rotation, flips said container in order to transfer said one or more objects from said container to said second transfer device, said mobile structure also being configured to hold said container when it is in said unloading position.

3. Apparatus as in claim 2, wherein said mobile structure comprises a support plane substantially aligned with said level in order to receive the container thereon, said support plane being rotatable about said axis of rotation.

4. Apparatus as in claim 2, wherein said mobile structure also comprises retention members configured to hold the container when the mobile structure is in the unloading position.

5. Apparatus as in claim 2, wherein it also comprises a fixed structure within which said mobile structure is disposed in a rotary manner, said fixed structure having at least one closed lateral wall and a lower aperture through which said one or more objects pass in order to reach said underlying second transfer device, when said mobile structure is in said unloading position.

6. Apparatus as in any claim 1, wherein said second transfer device is mobile between a receiving operating condition, in which said first body receives said one or more objects from said first transfer device, and an unloading operating configuration, in which said first body is disposed in said inclined position in order to transfer said one or more objects directly into said box.

7. Apparatus as in claim 1, wherein said second transfer device also comprises a second body, said first body being disposed above said second body and mounted rotatable about an axis of rotation.

8. Apparatus as in claim 7, wherein
said first transfer device comprises at least one mobile structure configured to accommodate a container which houses said one or more objects, said first transfer device being mobile about an axis of rotation between a loading position, in which said mobile structure receives said container housing said one or more objects from transport means, and an unloading position in which said mobile structure, after having rotated by a predefined angle about said axis of rotation, flips said container in order to transfer said one or more objects from said container to said second transfer device, said mobile structure also being configured to hold said container when it is in said unloading position, and
said axis of rotation of said first body is perpendicular to said axis of rotation of said first transfer device.

9. Apparatus as in claim 7, wherein said first body and said second body have a reciprocally mating transverse shape, substantially V-shaped, wherein said second body is configured to at least partly contain said first body.

10. Apparatus as in claim 9, wherein at least one of either said first body or said second body comprises two motorized belts inclined so that each forms a respective side of the V.

11. Apparatus as in claim 7, wherein said second body is mounted slidingly on a support, between a retracted position in which said second body is disposed completely under the first body and an advanced position in which said second body is only partly disposed under the first body, in such a way so as to receive said one or more objects (O) from said first body and then let them fall directly into said box (S).

12. Apparatus as in claim 11, wherein said support is fixed and disposed inclined with respect to said level or in that said support is mobile so as to be able to vary the inclination of at least said second body with respect to said level.

13. Apparatus as in claim 1, wherein said level lies on a substantially horizontal plane.

14. Method for automatically introducing one or more objects into boxes, wherein it comprises:
a step of feeding an empty box into an introduction zone, said box having a closed bottom and an opposite upper aperture;
a step of supplying to a first transfer device one or more objects to be introduced into said box at a level disposed above said introduction zone;
a first step of transferring said one or more objects, by gravity, from said first transfer device to a second transfer device disposed between said level and said introduction zone;
a second step of transferring said one or more objects, by gravity, from said second transfer device directly to said box, wherein the second transfer step provides to rotate, about an axis of rotation, a body of said second transfer device so that said body is disposed inclined by a determinate angle of inclination with respect to a horizontal plane in order to facilitate the descent of said one or more objects directly toward said box.

15. Method as in claim 14, wherein said second transfer step provides to dispose said second transfer device in contact with flaps of the box which delimit said upper aperture.

16. Method as in claim 14, wherein it comprises, before the step of supplying said one or more objects to said first transfer device, a step of removing said empty box from a magazine having a plurality of boxes of different sizes, the choice of the size of the box to be subsequently disposed in the introduction zone being made as a function of the size of said one or more objects that will be inserted, so as to minimize the empty space not occupied by said one or more objects after they have been introduced into said box.
